(19) United States
(12) Patent Application Publication
(10) Pub. No.: US 2002/0080535 A1
(43) Pub. Date: Jun. 27, 2002

(54) Multiple ground fault trip function system and method for same

(76) Inventors: David L. Swindler, Murfreesboro, TN (US); Henry Zylstra, Alburnett, IA (US); Mitchell Whitson Lampley, Thompson Station, TN (US)

Correspondence Address: Larry I. Golden, Square D. Company, 1415 South Roselle Road, Palatine, IL, 60067, US

(21) Appl. No.: 09/748,683

(22) Filed: Dec. 22, 2000

(51) Int. Cl. H02H 3/32

(52) U.S. Cl. 361/44; 361/42

(57) ABSTRACT

A ground fault protection system and method for implementing such is provided for protecting an electrical power distribution system having multiple sources and multiple grounds. A set of current transformers are connected to an interface unit which in turn is connected to a ground fault trip function for a circuit breaker. The interface unit has an output with a low impedance, and the outputs of multiple interface units can be connected in series and feed a single ground fault trip function; thereby tripping the circuit breaker on a ground fault detected by any set of current transformers connected to one of the interface units. Another embodiment utilizes multiple, independent ground fault trip functions in a single circuit breaker. Each ground fault trip function is connected to a set of current transformers, and the circuit breaker will trip if any connected set of current transformers detects a ground fault. This embodiment involves a system whereby one circuit breaker is tripped under ground fault conditions using one signal from either of two or more inputs from different groups of sensor circuits. A method is disclosed that includes the steps of sensing the current at various points in the distribution system, monitoring the sensed current for a ground fault, determining which breakers need to be tripped for a detected ground fault, and tripping those breakers.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention relates generally to ground fault protection circuits for electrical distribution equipment. More particularly, this invention pertains to a circuit and implementing method for ground fault protection for electrical power distribution systems having multiple sources and grounds.

2. Description of the Related Art

Ground fault protection circuits are commonly used for providing automatic circuit interruption upon detection of undesired short circuit currents that flow as a result of a ground fault condition in electrical power distribution systems. Such ground fault protection circuits ordinarily include means for quickly sensing and individually isolating any faults occurring in a respective branch circuit of the power distribution systems and utilize selective coordination to instantly respond and interrupt power only to the system area where a fault occurs, preventing unnecessary loss of power to other areas.

FIG. 1 illustrates a simple co-generation distribution system of the prior art that utilizes a simple ground fault protection system. Each of the circuit breakers is controlled by a ground fault trip function that monitors for fault currents flowing through the breaker. A fault resulting in unbalanced currents flowing through the neutral and phase conductors trips the breaker. With both the main supply breaker and the generator breaker closed, the ground fault protection system configuration depicted in FIG. 1 will isolate all ground faults except for a ground fault on the main bus when power is supplied to the bus from the generator.

FIG. 2 illustrates the same co-generation distribution system, but the system utilizes a ground fault protection system as taught in U.S. Pat. No. 5,751,524, issued on May 12, 1998, to Swindler. FIG. 2 shows a ground fault protection system using the main circuit breaker current transformer to provide a trip signal to both the main circuit breaker ground fault trip function and to the generator breaker ground fault trip function. The generator breaker ground fault trip function is coupled to the main circuit breaker current transformer through an auxiliary transformer, which causes the generator breaker to trip when a ground fault is detected on the main bus. The use of auxiliary transformers permits a single set of current transformers to trip more than one circuit breaker. Although having this advantage, the use of auxiliary transformers also has the disadvantage of increasing the number of different types of components in the circuit and of requiring additional wiring between the various breakers. With breakers located in different areas, it is desirable to minimize the wiring between breakers.

### BRIEF SUMMARY OF THE INVENTION

An improved ground fault protection system and method for implementing such is provided for protecting an electrical power distribution system having multiple sources and multiple grounds. In one embodiment, two sets of current transformers, each monitoring a different point in the distribution system, are each connected to separate interface units. The outputs of these two interface units are connected in series and feed the trip function of a circuit breaker, thereby providing the circuit breaker with the ability to trip on the detection of a ground fault sensed by either set of current transformers. Another embodiment connects one set of current transformers to two interface units in series. With the outputs of the interface units connected to different circuit breakers, this embodiment trips two circuit breakers based on a ground fault sensed by the set of current transformers. Still another embodiment of the invention includes a circuit breaker with two independent ground fault trip functions, effectively incorporating the interface units with the ground fault trip function in the circuit breaker.

The method for implementing the ground fault protection system includes sensing the current at various points in the distribution system and monitoring for a ground fault. When a ground fault is detected, the circuit breakers necessary to isolate the ground fault are determined and tripped. In order to isolate the ground fault, multiple breakers may need to be tripped based on a single point where a ground fault was sensed.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a schematic representation of a representative power distribution system having a ground fault protection circuit according to the prior art;

FIG. 2 is a schematic representation of a representative power distribution system having a ground fault protection circuit according to the prior art;

FIG. 3 is a schematic representation of a representative power distribution system having a ground fault protection circuit according to an embodiment of the present invention;

FIG. 4 is a schematic representation of the power distribution system depicted in FIG. 3 and showing per-unit fault currents in the primary conductors of the system;

FIG. 5 is a schematic representation of the power distribution system depicted in FIG. 3 and showing per-unit currents sensed by the ground fault protection circuits as would flow in the secondary of the sensors and to the trip function;

FIG. 6 is a schematic representation of the generator circuit breaker ground fault trip function as depicted in FIGS. 3, 4, and 5;

FIG. 7 is a schematic representation of a circuit breaker with a single ground fault trip function fed by two interface units according to the present invention;

FIG. 8 is a schematic representation of a circuit breaker with two ground fault trip functions according to the present invention; and

FIG. 9 is a schematic representation of a complex power distribution system having a ground fault protection circuit according to one embodiment of the present invention.

### DETAILED DESCRIPTION OF THE INVENTION

A ground fault protection system and method for implementing such is provided for protecting an electrical power distribution system having multiple sources and multiple grounds.

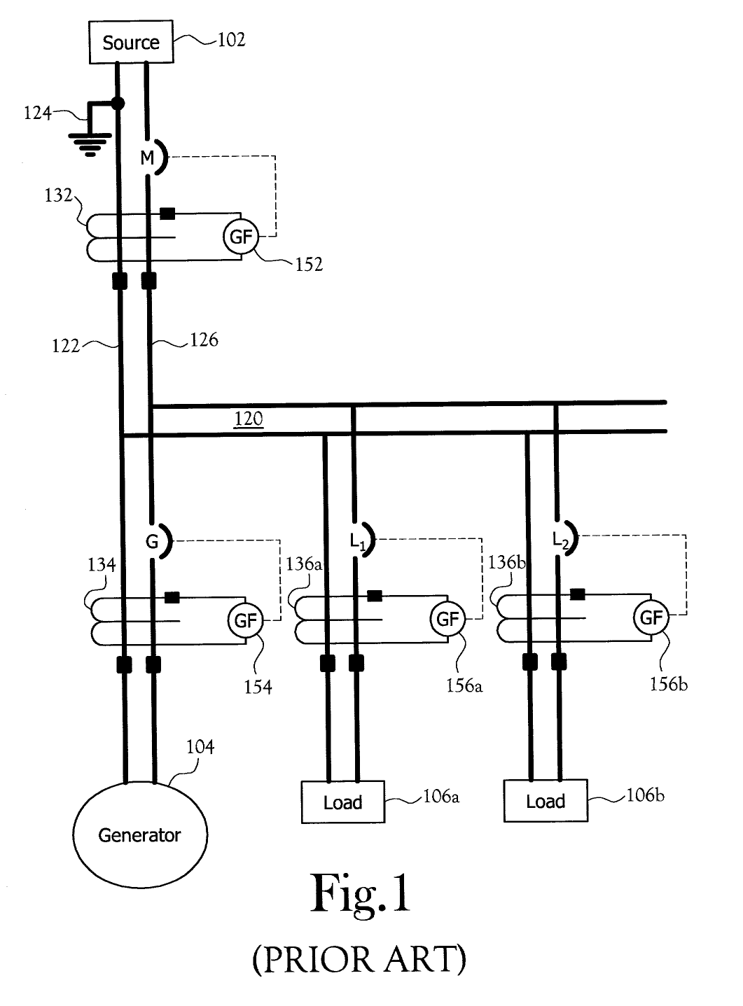

FIGS. 1 through 5 show a single-line diagram of a simple three-phase four-wire electrical co-generation distribution system. The single-line diagrams use a single line to represent the three-phase power and another line to represent the neutral.

In FIGS. 1 through 5, an off-site source 102 is shown connected to the distribution bus 120 by a main supply breaker M. A generator 104 is connected to the distribution bus 120 by a generator breaker G, and two loads 106a, 106b are connected to the distribution bus 120 by load breakers L1 and L2. Each breaker M, G, L1, L2 has an associated current sensor or current transformer (CT), 132, 134, 136a, and 136b, respectively.

FIGS. 1 through 5 show each CT 132, 134, 136 encompassing the three phases 126 and neutral 122. This is a representation of the actual circuit in which individual current transformers are used for each phase 126 and the neutral 122, with the current transformer secondaries connected in parallel. The set of current transformers measure the vector sum of the currents flowing through the phase conductors and the neutral conductor. Without a ground fault present, the vector sum is zero. The polarities of the CTs 132, 134, 136 are indicated by the square black dots (polarity mark) adjacent to the windings. More specifically, when primary current enters a given primary winding through the black dot adjacent to this primary winding, secondary current leaves the associated secondary winding through the black dot adjacent to the secondary winding. When the direction of the primary current is reversed, the direction of the secondary current is correspondingly reversed. The figures show the neutral conductor 122 electrically connected to ground 124.

FIG. 1 shows a simple co-generation distribution system with a simple prior art ground fault protection system. Each breaker M, G, and L has a ground fault trip function 152, 154, 156 connected to a CT 132, 134, 136 associated with that breaker M, G, or L. With both the main supply breaker M and the generator breaker G closed, the ground fault protection system configuration depicted in FIG. 1 will isolate all ground faults except for a ground fault on the main bus 120, because the generator ground fault detection system is incapable of detecting the ground fault by means of the power flow through the generator circuit breaker. With a ground fault on the main bus 120, the main supply breaker M will trip, but the generator breaker G will remain closed.

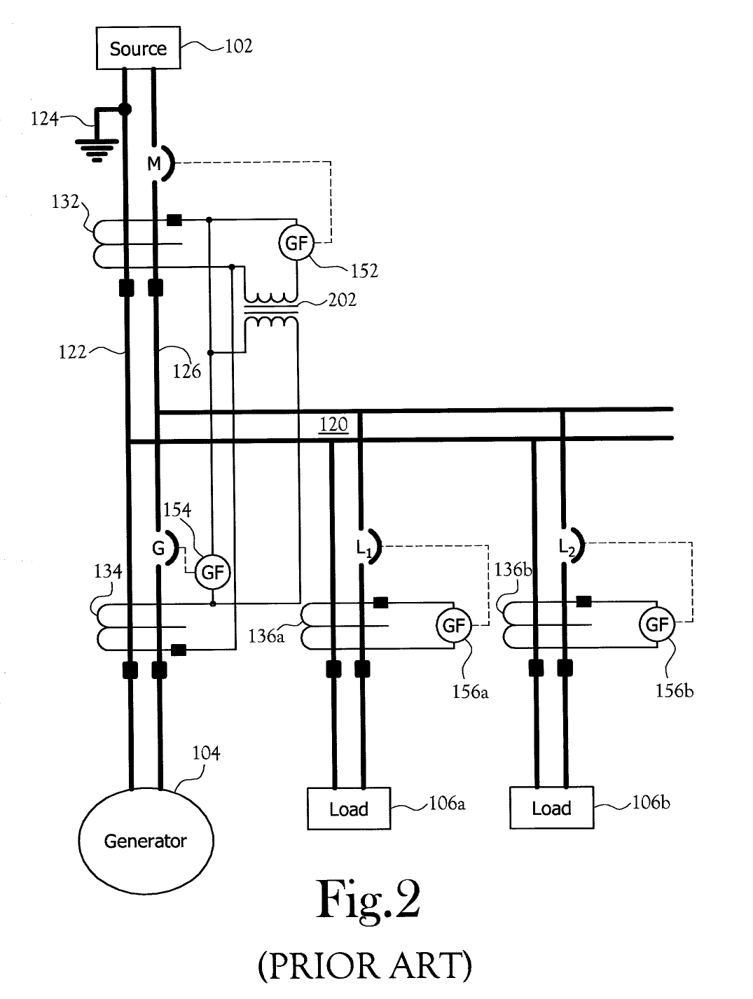

FIG. 2 depicts a similar distribution system with a ground fault protection system as taught by the Swindler patent. An auxiliary transformer 202 is used to actuate the ground fault trip function 154 for the generator breaker G when a ground fault is detected by the main supply breaker M CT 132. The ground fault protection system depicted in FIG. 2 will isolate all ground faults, including a ground fault on the main bus 120.

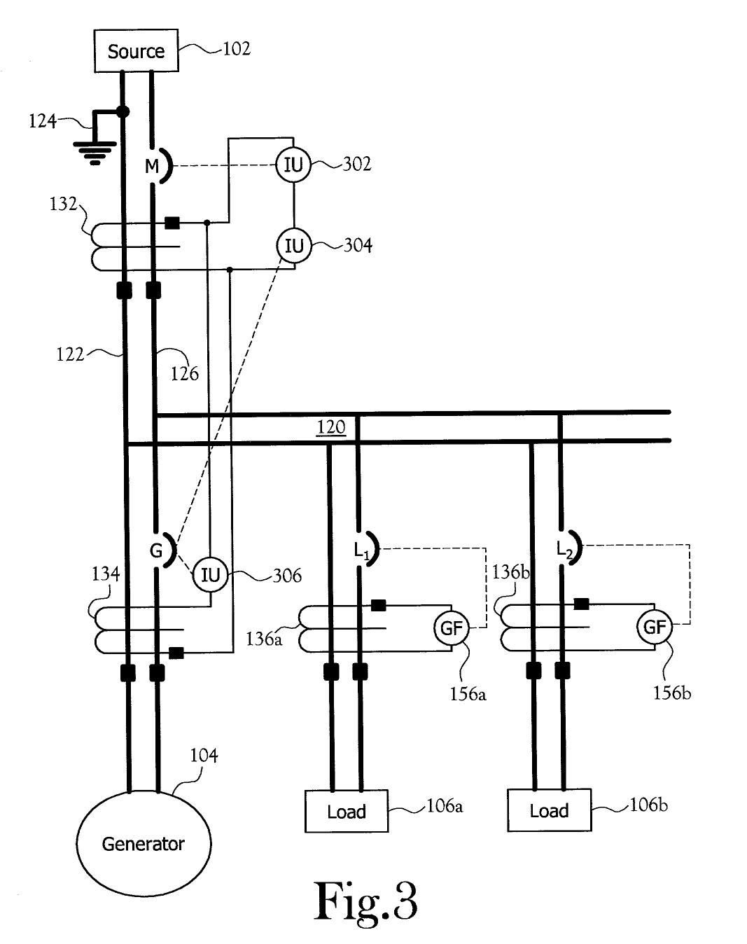

FIG. 3 illustrates one embodiment of the present invention, which uses a plurality of interface units 302, 304, 306 to form the ground fault protection system. Each interface unit 302, 304, 306 is an impedance matching device in which the input is either directly connected to a CT or forms part of a loop containing any combination of CTs, ground fault trip functions, and other interface units. The output of the interface unit has a low impedance and can directly drive a ground fault trip function, which has a high impedance, or the output can be placed in series with another interface unit to drive a single ground fault trip function, with either interface unit capable of causing the ground fault trip function to trip the circuit breaker. Additionally, in a variation of this embodiment, the interface unit can be adjusted or calibrated by changing a resistor in the interface unit's output network. As shown, interface units 304, 306 are used to communicate a pair of ground fault trip signals to the generator circuit breaker G, eliminating the need for the auxiliary transformer 202 shown in FIG. 2.

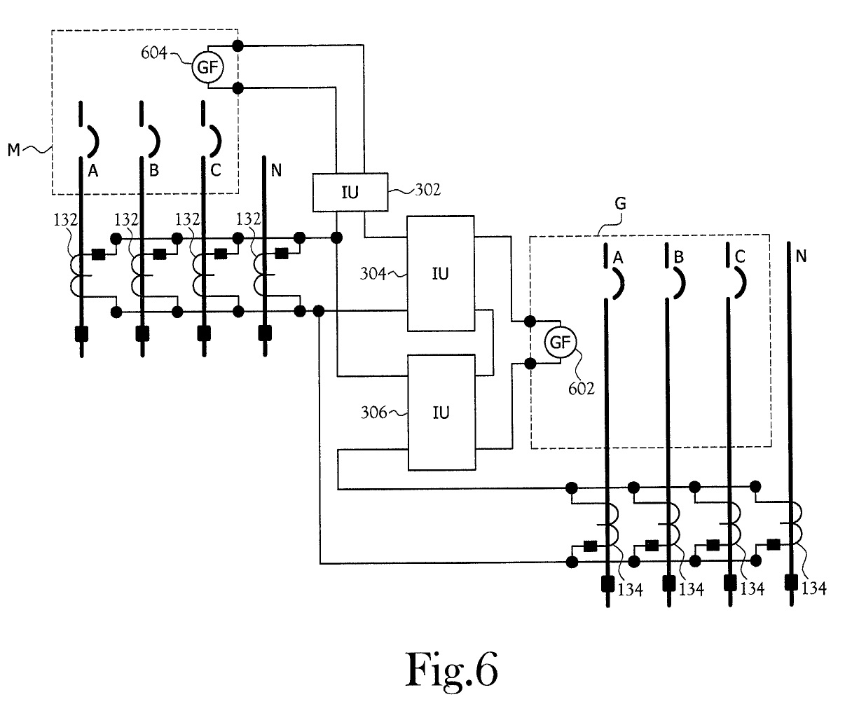

FIG. 6 illustrates a schematic of main supply breaker M and generator breaker G connected as depicted in FIG. 3. The outputs of two interface units 304, 306, wired in series, are connected to the ground fault trip function 602 of generator breaker G. The input of one of the interface units 304 is in series with another interface unit 302 and a set of CTs 132. The output of the interface unit 302 is connected to the ground fault trip function 604 of the main supply breaker M. The input of the other interface unit 306 is connected to a set of CTs 134 located near the generator breaker G. A ground fault sensed by the set of CTs 132 near the main supply breaker M will cause both the main supply breaker M and the generator breaker G to trip.

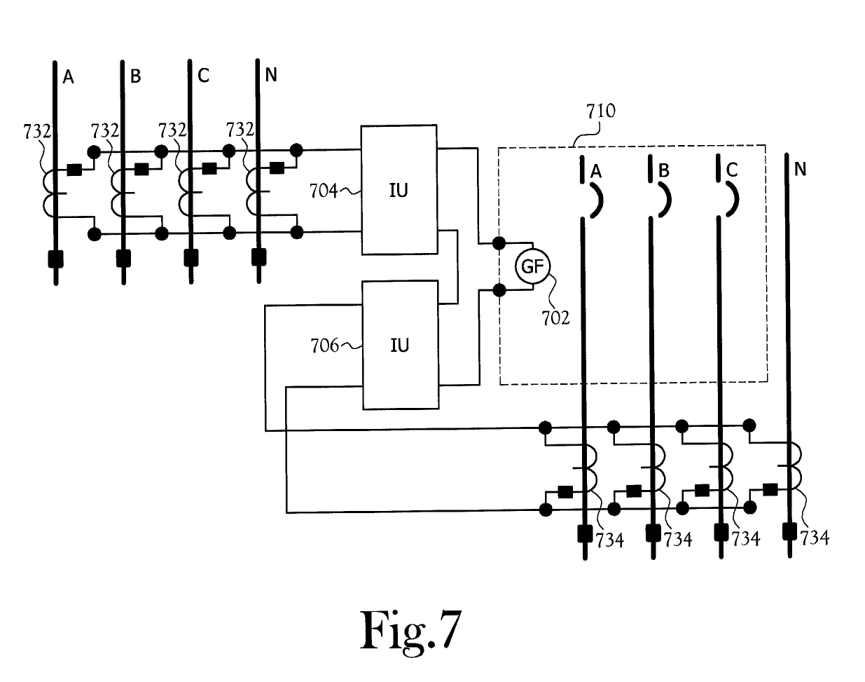

FIG. 7 illustrates a schematic of an embodiment where a single circuit breaker 710 can be tripped from either of two sets of current sensors or CTs 732, 734. FIG. 7 shows a common circuit breaker 710 with a single ground fault trip function 702. A pair of interface units 704, 706 have their outputs wired in series and connected to the ground fault trip function 702. The input of each interface unit 704, 706 is connected to a set of CTs 732, 734. The interface units 704, 706 have a low output impedance and each interface unit 704, 706 can individually trip the ground fault trip function 702.

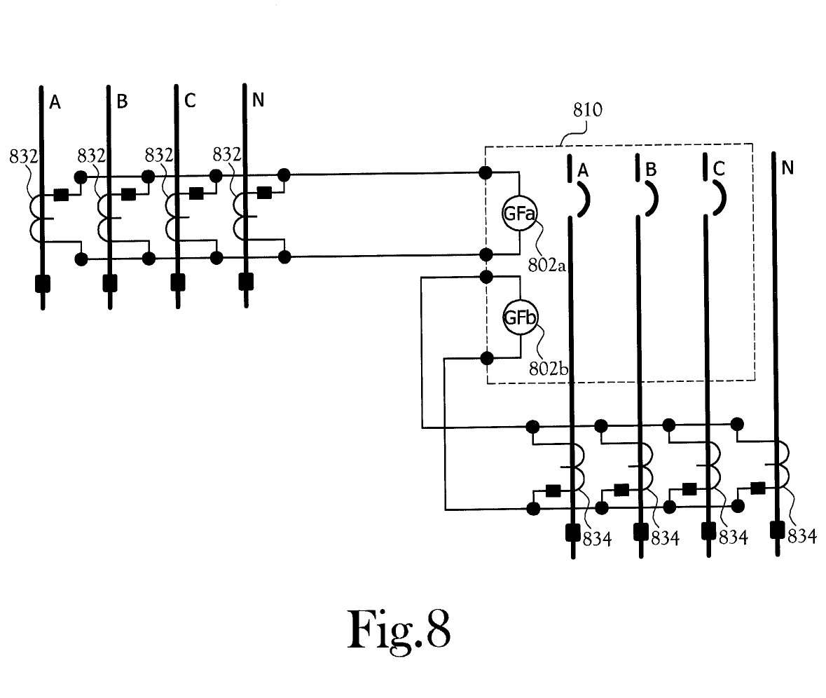

FIG. 8 illustrates a schematic of an embodiment in which multiple interface units are incorporated into a single circuit breaker 810. A circuit breaker 810 is constructed with two independent ground fault trip functions 802a, 802b, either of which can trip the breaker 810. Each ground fault trip function 802a, 802b is connected to a set of CTs 832, 834. Those skilled in the art will recognize that the ground fault trip function 802 can either mechanically or electrically trip the circuit breaker 810 without departing from the spirit and scope of the present invention.

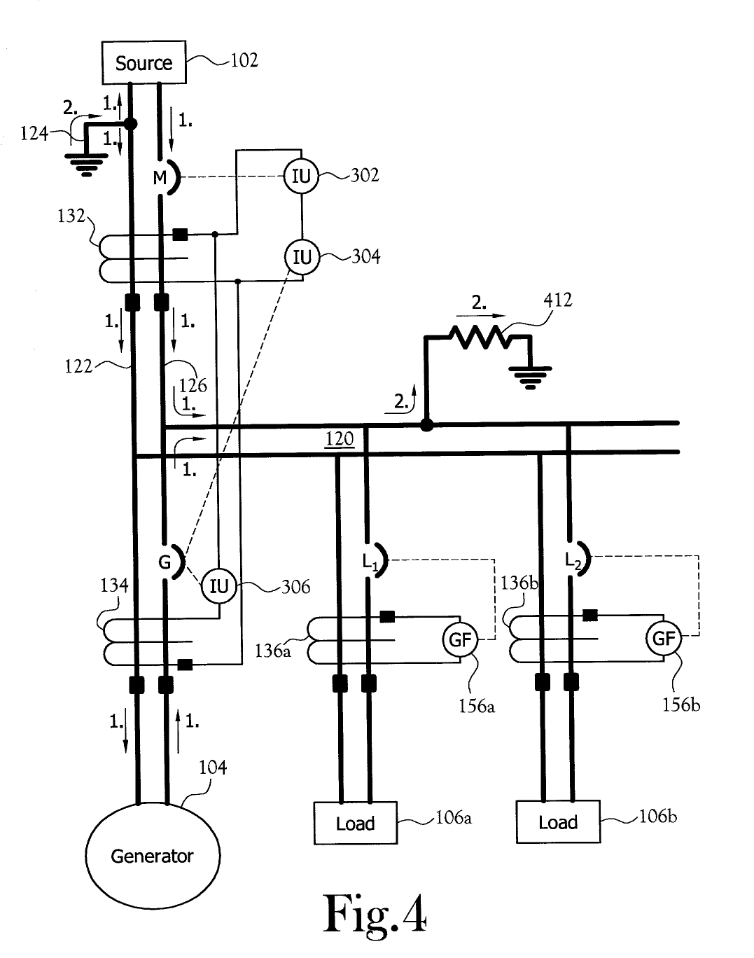

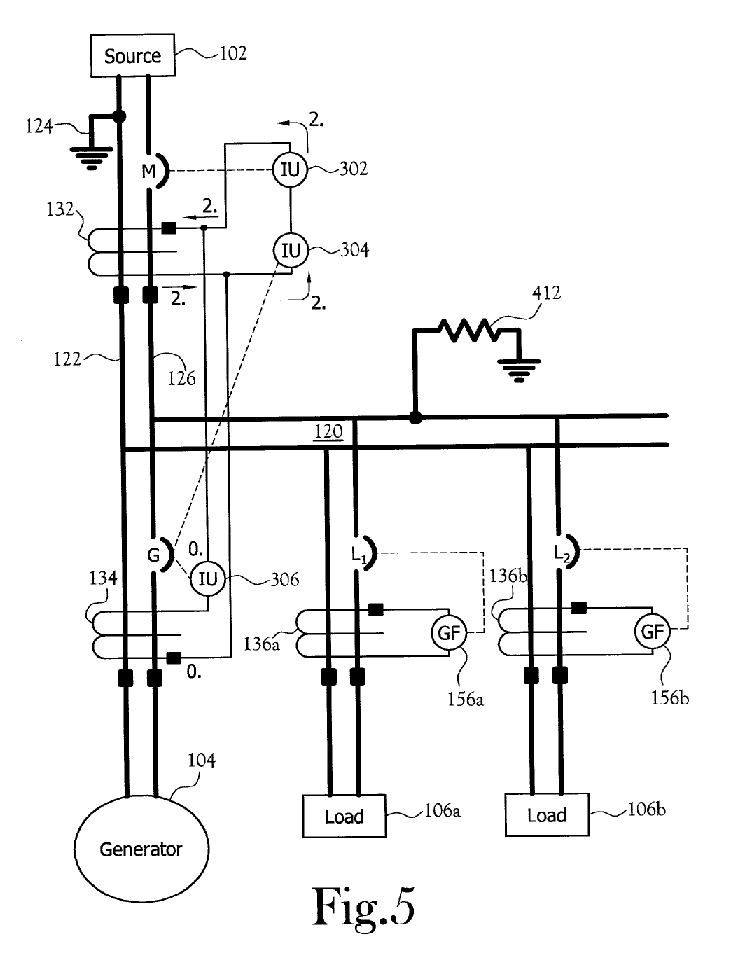

FIGS. 4 and 5 illustrate the steps for analyzing a ground fault protection system. In these two figures, the underlying assumption is that all breakers M, G, L are closed, that there is a ground fault 412 on the bus 120, and that the ground fault 412 consists of 2 units of current. According to Kirchoff's first law, if current is flowing from the sources, then current must return to the sources and whatever current returns to the source must equal that which is going out.

FIG. 4 illustrates the flow of the fault current resulting from the ground fault 412. A current of 2 units flows out of the system at ground fault 412 and flows back into the system at the ground connection 124. From the ground connection 124, the current splits with 1 unit flowing towards the source 102 and 1 unit flowing down the neutral 122 through the main supply CT 132, through the generator CT 134, into the generator 104, through the generator 104, through the generator CT 134, and then flowing out of the system through the ground fault 412. The 1 unit of current flowing into the neutral 122 from the ground connection 124 flows into the source 102, returns from the source 102, through the main supply CT 132, and then flowing out of the system through the ground fault 412.

The ground fault current flowing through the neutral 122 and phase conductors 126 at CT 132 is flowing away from the polarity marks. Accordingly, the current flow through the secondary of the CT 132, as shown on FIG. 5, is the sum of the two currents, which is 2 units of current, and the current flow is towards the CT 132 from the polarity mark. With respect to CT 134, the neutral current of 1 unit is flowing away from the polarity mark and the phase conductors current of 1 unit is flowing into the polarity mark. These two currents cancel each other and, as shown on FIG. 5, result in zero current flow in the secondary of CT 134.

FIG. 5 shows the current flowing through the secondaries of the CTs 132, 134. Current transformer 132 has 2 units of current flowing into its secondary winding, and CT 134 has zero current flowing through its secondary. Because there is no current contributed by CT 134, interface unit 306 will not trip the generator breaker G. However, the 2 units of current generated by the main supply CT 132 flows though the loop formed by the CT 134, interface unit 304, and interface unit 302. This current flow causes interface unit 302 to trip the generator breaker G on a ground fault and causes interface unit 304 to trip the main supply breaker M on a ground fault. With both breakers M, G open, the ground fault 412 is isolated.

Those skilled in the art will recognize that the analysis described above and illustrated in FIGS. 4 and 5 can be used on more complex electrical power distribution systems and with different assumptions regarding the location of the ground fault 412 and status of the various circuit breakers without departing from the spirit and scope of the present invention. Complex power distribution systems include multiple power sources and tie buses, which are configured such that power can be supplied to any load from various sources. The ground fault protection system, for both a simple and a complex power distribution system, must isolate any ground fault and minimize the disruption of loads.

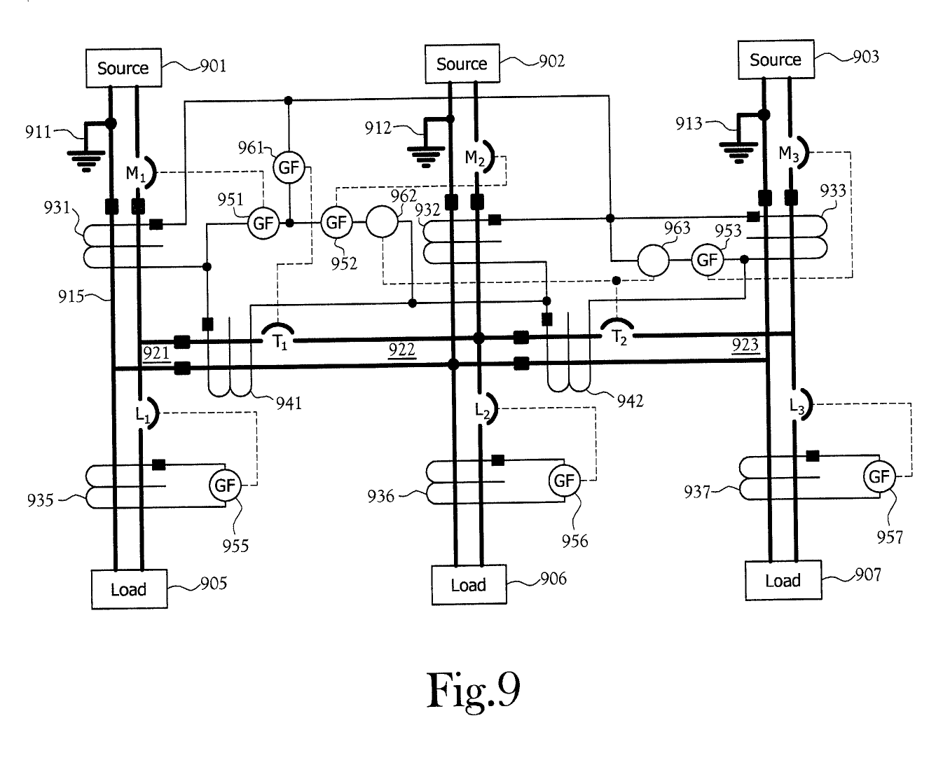

FIG. 9 is an example of a more complex power distribution system. Three power sources 901, 902, 903 are connected to three buses 921, 922, 923, respectively, and feed three loads 905, 906, 907, respectively. Each power source 901, 902, 903 is connected to the buses 921, 922, 923 with a main supply circuit breaker M1, M2, M3. The buses 921, 922, 923 are connected with tie breakers T1, T2, as shown. The three load circuit breakers L1, L2, L3 have standard ground fault protection provided by monitoring the breaker L1, L2, L3 outputs with CTs feeding the breaker's ground fault trip function.

The ground fault protection system for the remainder of the power distribution system uses an embodiment of the present invention. Each of the main supply circuit breakers M1, M2, M3 has an associated CT 931, 932, 933 and each of the tie breakers T1, T2 has an associated CT 941, 942. The ground fault trip function 951 for the first main source circuit breaker MI and the ground fault trip function 961 for the first tie breaker T1 form two legs of an illustrated star connection that is bridged by the first main source CT 931. The third leg of the illustrated star connection includes the ground fault trip function 952 for the second main source circuit breaker M2 and either an interface unit 962 with an output connected to the second tie breaker T2 or one of two ground fault trip functions 962 in the second tie breaker T2. The outboard end of the third leg is connected to the shared connection between the tie breaker CTs 941, 942. The ground fault trip function 953 for the third main source circuit breaker M3 is in series with either an interface unit 963 with an output connected to the second tie breaker T2 or one of two ground fault trip functions 963 in the second tie breaker T2.

When two interface units 962, 963 are used, , as shown in FIG. 7, the outputs of the two interface units 962, 963 are connected in series and feed the ground fault trip function for the second tie breaker T2. When two independent and isolated trip functions 962, 963 in a single circuit breaker T2 are used, as shown in FIG. 8, either trip function 962, 963 will trip the second tie breaker T2.

The ground fault protection system illustrated in FIG. 9 isolates only that portion of the system necessary to isolate the ground fault. In order to accomplish this, the ground fault protection system uses either two interface units or two independent trip functions to ensure that the tie breakers trip when required.

In operation, current sensors or CTs are used to sense current flowing at various points in power distribution systems, regardless of whether the power distribution system is simple or complex. These points are typically near circuit breakers, where bus current is sensed, and ground points, where ground current is sensed. Bus current is measured from the vector sum of currents flowing through each phase conductor and through the neutral conductor of the bus. Ground point current is measured by sensing the current flowing through the ground connection.

The sensed current is monitored for a ground fault, which is sensed by a non-zero current in the bus or the ground connection. Once a ground fault is detected, the ground fault protection system determines which circuit breakers need to be tripped in order to isolate the ground fault and trips the breakers. The determination of the breakers to be tripped is based upon the location of the ground fault and the topology of the power distribution system. An analysis as illustrated in FIGS. 4 and 5 can be used to analyze the ground fault protection system to ensure that the breakers to be tripped are those that can supply power to the ground fault. As illustrated in the figures, this determination requires one or more circuit breakers to be tripped based on a ground fault detected from any of multiple current sensing locations.

From the forgoing description, it will be recognized by those skilled in the art that an improved ground fault protection system and method is provided for protecting an electrical power distribution system having multiple sources and multiple grounds. This system and method does not require the use of auxiliary transformers.

While some embodiments have been shown and described, it will be understood that it is not intended to limit the disclosure, but rather it is intended to cover all modifications and alternate methods falling within the spirit and the scope of the invention as defined in the appended claims.

Having thus described the aforementioned invention, we claim:

1. A ground fault protection circuit for an electrical power distribution system having a plurality of polyphase power sources, each associated with a main circuit breaker, connected to a plurality of polyphase buses which are electrically connected by a plurality of tie breakers, said ground fault protection circuit comprising:
a first current sensor associated with a corresponding bus having a plurality of phase conductors and a neutral conductor, said first current sensor having a sensor output and located adjacent to the corresponding bus and developing a first trip current through the sensor output that varies directly with the vector sum of currents flowing through the plurality of phase conductors and the neutral conductor at the location of said first current sensor;
a first trip function associated with a first circuit breaker, wherein a trip function current flowing through said first trip function causes the first circuit breaker to trip; and
a first interface unit having an input in communication with said first current sensor and an output in communication with said first trip function, wherein said first interface unit receives said first trip current and causes said first trip function to receive a second trip current, which is related to the first trip current;
whereby the first circuit breaker trips when a ground fault occurs in a power distribution system and is sensed by said first current sensor.

2. The ground fault protection circuit according to claim 1, further comprising
a second interface unit, said interface units having a low output impedance, wherein said first interface unit can drive said first trip function when said first interface unit is in a loop containing said second interface unit and said first trip function.

3. The ground fault protection circuit according to claim 1, further comprising
a second trip function associated with a second circuit breaker; and
a second interface unit, said first interface unit input wired in series with said second interface unit input, wherein said first trip current flows through said first interface unit and said second interface unit, and said first interface unit causes said first trip function to trip the first circuit breaker, and said second interface unit causes said second trip function to trip the second circuit breaker.

4. The ground fault protection circuit according to claim 1, further comprising
a second trip function associated with a second circuit breaker,
wherein said first interface unit input is wired in series with said second trip function and said first current sensor, said first trip current flows through said first interface unit and said second trip function, said first interface unit causes said first trip function to trip the first circuit breaker, and said second trip function trips the second circuit breaker.

5. The ground fault protection circuit according to claim 1, further comprising
a second current sensor;
a second interface unit having an input in communication with said second current sensor, said second interface unit having an output wired in series with said first interface unit output and said first trip function, wherein said second trip current flows through said first interface unit output and said second interface unit output and causes said first trip function to trip the first circuit breaker.

6. The ground fault protection circuit according to claim 5, wherein said first trip function, said first interface unit, and said second interface unit are integrated into the first circuit breaker.

7. The ground fault protection circuit according to claim 1, wherein said first trip function and said first interface unit are combined into a single unit.

8. A ground fault protection circuit for an electrical power distribution system, said ground fault protection circuit comprising:
a plurality of ground fault trip functions associated with a circuit breaker, wherein any one of said plurality of ground fault trip functions causes the circuit breaker to trip.

9. A ground fault protection circuit for an electrical power distribution system, said ground fault protection circuit comprising:
a means for tripping a circuit breaker, said means for tripping responsive to any one of a plurality of ground fault trip signals.

10. A ground fault protection circuit for an electrical power distribution system, said ground fault protection circuit comprising:
a first current sensor associated with a corresponding bus having a plurality of phase conductors and a neutral conductor, said first current sensor having a sensor output and located adjacent to the bus for generating a first trip current through the sensor output that varies directly with the vector sum of currents flowing through the plurality of phase conductors and the neutral conductor at the location of said first current sensor;
a first trip function associated with a first circuit breaker, wherein a trip function current flowing through said first trip function causes the first circuit breaker to trip; and
a first means for interfacing said first current sensor to said first trip function, wherein said first trip function causes the first circuit breaker to trip based on a ground fault detected by said first current sensor.

11. The ground fault protection circuit according to claim 10, further comprising
a second trip function associated with a second circuit breaker; and
a second means for interfacing said first current sensor to said second trip function;
whereby when said ground fault is detected by said first current sensor, said first trip function causes said first circuit breaker to trip and said second trip function causes said second circuit breaker to trip.

12. The ground fault protection circuit according to claim 10, further comprising
a second trip function associated with a second circuit breaker, said first means for interfacing communicating with said first current sensor and said second trip function, wherein when said ground fault is detected by said first current sensor, said first means for interfacing causes said first circuit breaker to trip.

13. The ground fault protection circuit according to claim 10, further comprising
a second current sensor; and
a second means for interfacing said second current sensor to said first trip function;
whereby said ground fault detected by said first current sensor causes the first circuit breaker to trip.

14. A method for ground fault protection for an electrical power distribution system, said method comprising the steps of:
(a) sensing current associated with each of a plurality of circuit breakers, said step of sensing current including detecting a plurality of sensed currents with each being directly related to the vector sum of currents flowing through a plurality of phase conductors and a neutral conductor for each of said plurality of circuit breakers;
(b) monitoring said plurality of sensed currents for the presence of a ground fault;
(c) determining a selected set of said plurality of circuit breakers, which when tripped, will isolate said ground fault; and
(d) tripping said selected set of said plurality of circuit breakers when said step of monitoring determines the presence of said ground fault;
whereby a minimum number of said plurality of circuit breakers are tripped in order to isolate said ground fault.

15. The method according to claim 14, further comprising the initial step of employing means for interfacing a plurality of current sensors to a trip function.

16. The method according to claim 14, further comprising the initial step of using an interface unit with a low output impedance for matching a plurality of current sensors to a trip function.

17. The method according to claim 14, further comprising the steps of
sensing a ground current associated with each of a plurality of grounding points, said step of sensing said ground current including detecting a plurality of ground currents flowing through said plurality of grounding points; and
monitoring said plurality of ground currents for the presence of said ground fault.
